(19) United States
(12) Patent Application Publication
(10) Pub. No.: US 2022/0245719 A1
(43) Pub. Date: Aug. 4, 2022

(54) Home Improvement Bidding System

(71) Applicants: Oren Amir, Sherman Oaks, CA (US); Gil Hadad, Los Angeles, CA (US)

(72) Inventors: Oren Amir, Sherman Oaks, CA (US); Gil Hadad, Los Angeles, CA (US)

(21) Appl. No.: 17/590,171

(22) Filed: Feb. 1, 2022

Related U.S. Application Data
(60) Provisional application No. 63/144,824, filed on Feb. 2, 2021.

(51) Int. Cl. G06Q 30/08; G06Q 30/04; G06Q 30/06; G06Q 50/16

(52) U.S. Cl. CPC G06Q 30/08; G06Q 50/16; G06Q 30/0611; G06Q 30/04

(57) ABSTRACT

A computer system for homeowners (users) to submit home improvement and other home projects to providers for bidding. A user of the system may post a project to be bid on by service providers. A matching algorithm matches the user's project with a set of matching providers that can provide the requested services. Once a user's project is matched with a set of providers for the project, providers are able to bid on the project by providing pricing, timeline, representative projects, ratings, references and licenses. The user selects a bid for the project and the system creates an electronic contract for the project and provides for electronic signature by both parties. Any required licenses are uploaded to the system for verification and means are provided for connecting to state licensing APIs to automatically verify validity of state provided licenses. Materials may also be selected with the system. A project feed displays all communication and updates for the user and provider's easy review.

### PRIORITY

This application claims priority to Provisional Patent Application Ser. No. 63/144,824 filed on Feb. 2, 2021

### BACKGROUND OF THE INVENTION

### Field of the Invention

The present invention relates to computer systems for bidding for home improvement projects. Currently, when a homeowner desires to locate a provider for a home improvement project, the homeowner must look on multiple sites on the internet, collect data about providers and contact them individually to determine their availability, pricing and project timeline. This process is time consuming and error prone. This invention relates to computer systems connected to the internet, either mobile devices or laptop/desktop computers, that allow the user to set up project requirements, seek bids from qualified providers, review the bids, execute the contract and manage the process all from one software location.

### SUMMARY OF THE INVENTION

The present invention is a computer system for homeowners (users) to submit home improvement and other home projects to providers for bidding. Providers in the context of this disclosure could be contractors (general and sub), plumbers, electricians, tile installers, carpenters, handymen or another provider of services related to home improvement or construction. The term provider should be construed to include the broadest set of service providers of any type that might be contracted for a project around the home or office.

The present system and method allows a user of the system to post a project to be bid on by service providers. The matching algorithm disclosed as part of the system matches the user's project with a set of matching providers that are capable of providing the requested services. As will be discussed letter in the disclosure, the algorithm uses a variety of criteria to match users with providers, including type of project, budget, timeline, availability, location and quality of reviews. Once a user's project is matched with a set of providers for the project, providers are able to bid on the project by providing pricing, timeline, representative projects, ratings, references and licenses.

The user selects a bid for the project and the system creates an electronic contract for the project and provides for electronic signature by both parties. Any required licenses are uploaded to the system for verification and means are provided for connecting to state licensing APIs to automatically verify validity of state provided licenses.

Other unique feature of the platform is the ability to shop for materials for a project directly in the platform. Material providers can list products including pricing, images, ratings, specifications and availability directly in the platform, allowing the user to purchase the goods or include them in the project contract. Additionally, pre-selected packages of materials can be created by material providers or the platform operator, allowing users to easily select popular design options for kitchens, bathrooms, other interior/exterior designs, and other projects. Further, product listings are synced via the internet so that pricing and availability are kept current in real time.

All key project information is displayed in a project feed with specialized views for users and providers. Communications systems are provided for communicating within the platform and outside the platform with standard communications systems such as email, SMS/text messaging, instant messaging such as whatsapp and other industry standard messaging protocols.

Lastly, an integrated billing system provides tools for billing completed provider work and materials. The system generates invoices and integrates with electronic payment and credit card providers for automated billing and payment.

### BRIEF DESCRIPTION OF THE DRAWINGS

FIG. 1 is block diagram of the home improvement bidding system.

FIG. 2 is a block diagram of the user accounts module.

FIG. 3 is a block diagram of the provider accounts module.

FIG. 4 is a block diagram of the user project submission module.

FIG. 5 is a block diagram of the provider project response module.

FIG. 6 is a block diagram of the matching algorithm.

FIG. 7 is a block diagram of the project contract module.

FIG. 8 is a block diagram of the provider licensing module.

FIG. 9 is a block diagram of the project materials module.

FIG. 10 is a block diagram of the project information feed and messaging communications modules.

FIG. 11 is a block diagram of the billing module.

FIG. 12 is a flow chart of the user project submission method.

FIG. 13 is a flow chart of the provider project bid submission method.

FIG. 14 is a flow chart of the matching algorithm method.

FIG. 15 is a flow chart of the project completion method.

FIG. 16 is a view of the complete home improvement bidding system.

### DESCRIPTION OF THE PREFERRED EMBODIMENT

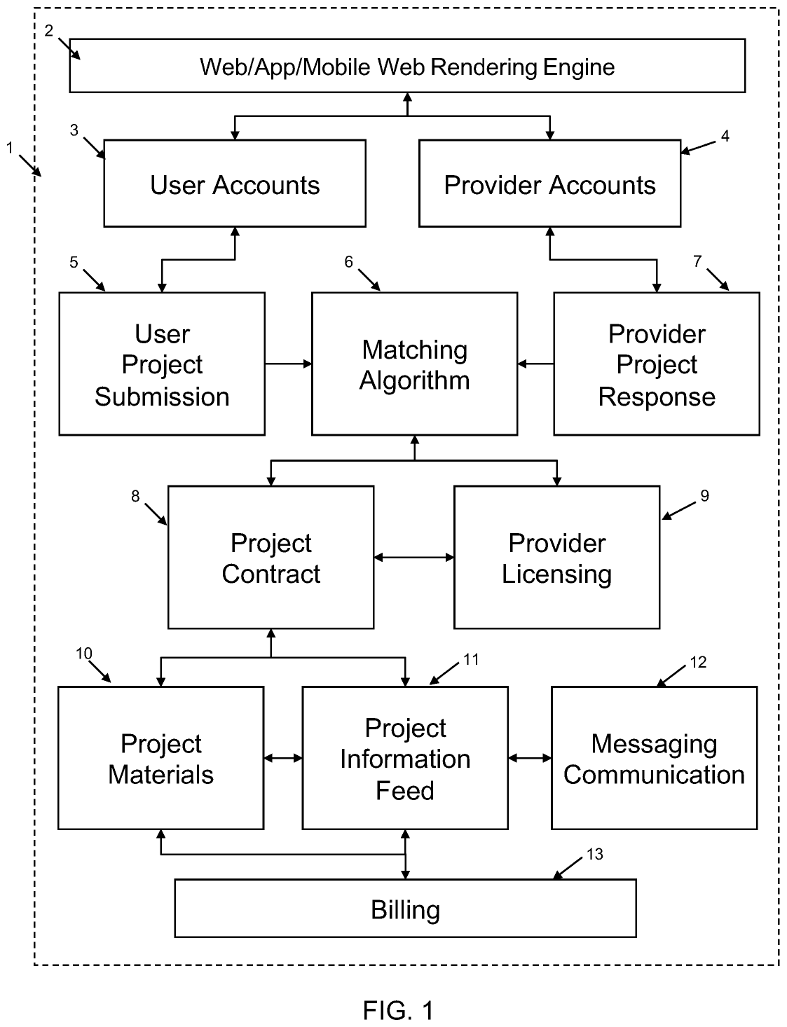

FIG. 1 shows a block diagram of the home improvement bidding system 1. Web/app/mobile web rendering engine 2 contains all the required software code to allow the system to be rendered on standard desktop websites, on both iPhone and Android apps as well as mobile web browsers such as Safari for iPhone or Chrome, Firefox and others for both iPhone, Android or any other smart phone devices. The rendering engine assures that the platform user interface displays in the proper format regardless of the device. The present invention is designed to be used on any computer or smart phone, as a standalone app (on a smartphone) and across all modern desktop and mobile browsers.

User Accounts 3 and Provider Accounts 4 store all the relevant login and profile data for both users and providers utilizing the platform. User project submission block 5 allows a user to assemble all the required information to submit a bid. Matching algorithm 6 matches user projects with appropriate providers based on various criteria. Provider project response 7 block allows a provider to assemble a detailed response to a user project including pricing, timeline, materials, references, licensing and other key criteria.

Once a provider bid is selected by a user, project contract 8 assembles a contract for the project with key contract terms, pricing, timeline, milestones, licensing and other relevant information. The contract can be electronically signed by both parties within the platform allowing paperless and instant contract execution. Provider licensing module 9 stores verified state and local licenses for providers. The provider licensing module further includes an API for real time verification and updates to licenses if provided by the state or local licensing authorities.

Project materials module 10 allows selection and purchase of materials for the project. The module allows materials sellers to keep up-to-date product listings including pricing, availability, specifications, ratings and other product criteria. The module is connected to the internet so relevant details are updated in real time.

Project information feed 11 provides a unique feed type project view for users and providers. The feed is assembled based on the type of platform user, either regular user or provider, and shows relevant updates about the project such as bid submitted, milestone reached and other important updates. The project information feed 11 connects directly to the messaging communications module 12 which provides internal messaging for the platform as well as connections to industry standard external communication protocols such as email, SMS/text, instant messaging like Whatsapp and others.

Lastly, billing module 13 provides the capability for invoicing and electronic payment processing for the system, thus simplifying and insuring quality payments within the platform. Each of these functions and features will be described in greater detail in the following figures.

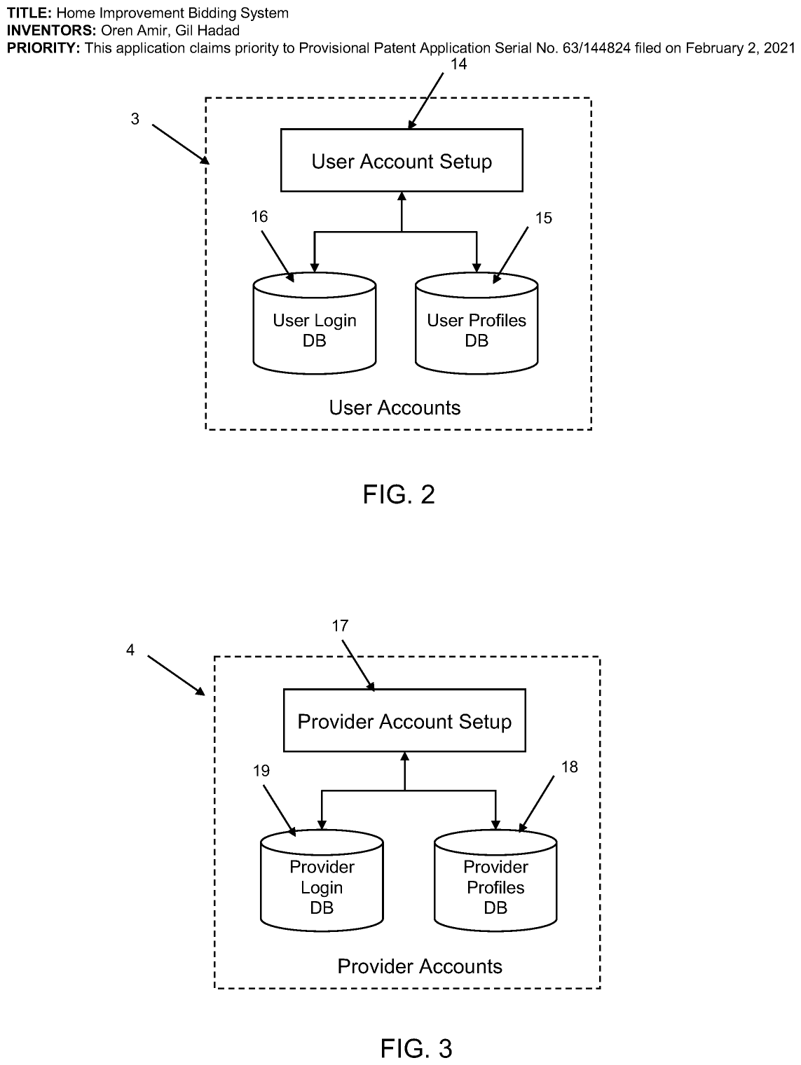

FIG. 2 shows the elements of user accounts module 3. User account setup module 14 helps new users of the platform setup all the required elements of their account, including their user login and user profile. The user login is a typical user login for an internet site or application and includes a username and password combination. Single Sign On (SSO) options are also utilized such as Google, Facebook and Apple. User login information is stored in User Login Database 16.

User Account Setup module 14 also assists new users in creating a user profile for the system. The user profile includes name, username, profile photo, project photos, location and various other information relevant to a specific user. Once a user profile is completed, the user profile for a specific user is stored in User Profile Database 15.

FIG. 3 shows the provider accounts module 4. Similarly to the user accounts module, the module includes a provider account setup module 17 that assists in setting up a provider account and profile. The setup includes provider login information that is structured in the same way as user login detail with a username, password and/or SSO sign on details. This information is stored in the Provider Login Database 19.

Provider account setup 17 also assists a provider with setting up a profile for their business. This profile includes provider/business name, provider type, address, phone, email, licenses held, project photos, representative projects and other key provider information. This provider profile information is stored in the Provider Profiles Database 18.

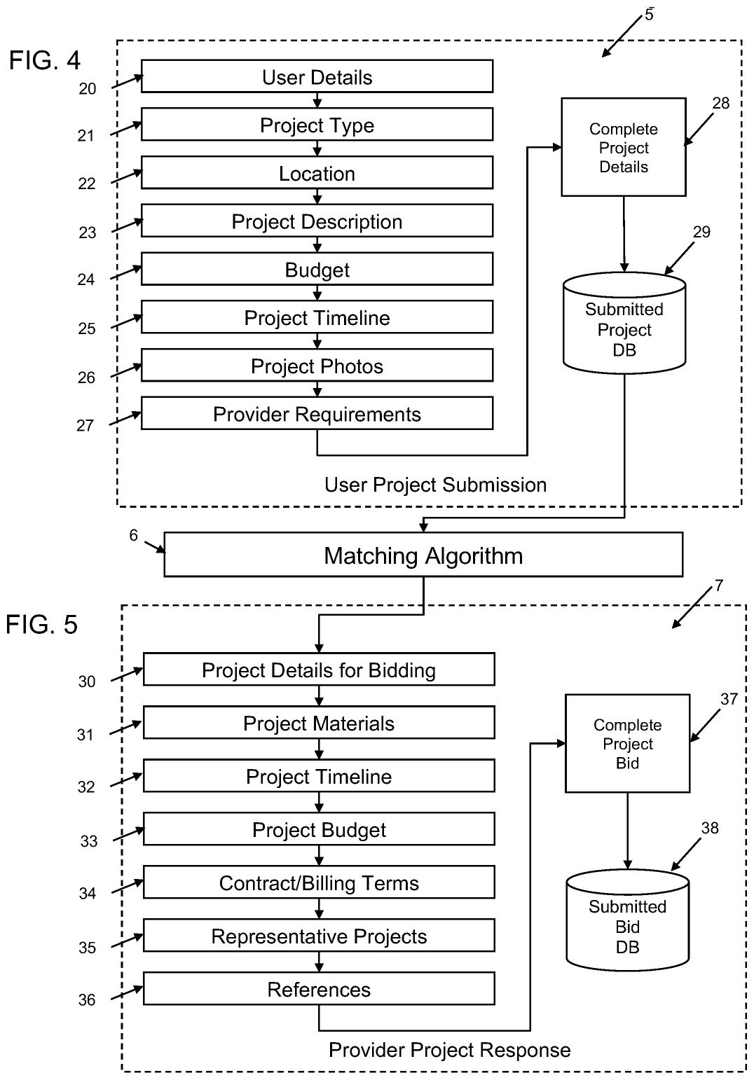

FIG. 4 shows the configuration and functions of user project submission module 4. In this module, a system user assembles all the required details for a project to be submitted to matched providers for bidding. To start the project submission process, the user provides required information in user details 20. This required information includes name, email, phone and other contact details. Much of this information can be ported from the user account details, if provided. The user may also provide additional or alternate information for use by providers.

Project type 21 includes a selection of typical projects like painting, carpentry, bathroom remodel, tile work, carpeting, flooring, electrical, plumbing, handy man, general contractor, kitchen remodel and many others. These selections are included in a drop down menu and a field is included for project types not listed on the drop down menu. Location 22 requires the user to provide the location of the project. This information can be carried over directly from the user account details, or can be provided in the form of a City/State, zip code or by sharing location from a mobile device.

Project description 23 provides a location for the user to include narrative details about the project they are submitting for bid. This is a free form text field where the user can include whatever details are relevant to their project. Project budget 24 includes a location for the user to indicate their expected cost/budget range for their project. This section includes radio buttons for various budget ranges or budget minimum or maximum fields for the user to input their budget values. Project timeline 25 includes options for the user to indicate their desired project timeline. Radio buttons are included with options such as: 1) As soon as possible; 2) within the next month; 3) 2-3 months, 4) 4-6 months and 5) within the next year. The user can also input any timeline requirements in a free form text box. Additionally, this input may be used to include any measurements relevant to the project. Project photos 26 allows the user to upload photos of the project location as well as photos of completed projects similar to their desired outcome.

Provider requirements 27 allows the user to select various criteria for the provider including minimum rating, state/city/local licensing, years in business, location, availability and other relevant project requirements. This also includes a free form text field for the user to include any requirements not presented within the selectable options. Once all the project details are complete, the complete project is shown to the user in complete project details 28.

Once approved by the user for submission, the project is loaded into the submitted project database 29. This database includes details about all the projects submitted for provider bids across the entire platform. This database is built using standard web application database technology well known in the art. These submitted projects are passed through matching algorithm 6 to be matched with appropriate providers for the project based on the project requirements.

FIG. 5 shows the functional blocks of provider project response module 7 where providers respond to matched project submissions from users. Project details for bidding 30 includes general provider information such as business name, location, address, phone numbers, email address(es), web addresses and other relevant business information. Project materials 31 allows the provider to select and suggest various materials from project materials module 10. This also allows pricing for various materials to be included in the bid. This module allows the provider to select the appropriate amount of materials such as carpet, flooring, tile, counter tops, siding, roofing or other project materials to be included in the bid. Project timeline 32 allows the provider to offer suggested timing for the project, including payment milestones, if included. Project budget 33 allows the provider to present the complete budget for the project including all materials and labor. The platform is setup to allow for material and finishing options resulting in budget ranges for a specific bid, as well as various additional options that can be selected by the user at increased cost.

Contract/billing terms 34 allows the provider to set any required contract terms such as insurance, upfront payment, worksite conditions, inspections, permits and other relevant project terms. It also allows any billing milestones for phases of project completion to be included in the contract. Representative projects 35 allows the provider to upload images and details about other similar projects completed by the provider for the user's review. The module includes photo upload, hyperlink upload and free form text upload. Lastly, references 36 allows the provider to include references from past clients for review by the user. Additionally, references 36 may include an ability to message clients for completed projects on the platform, or provide contact information for contact outside the platform to discuss a completed project by the provider. Once the bid is complete, the provider can review the complete project bid 37 and approve for submission. All submitted bids are stored in the submitted bid database 38. This database is built using standard web database technology well known in the art.

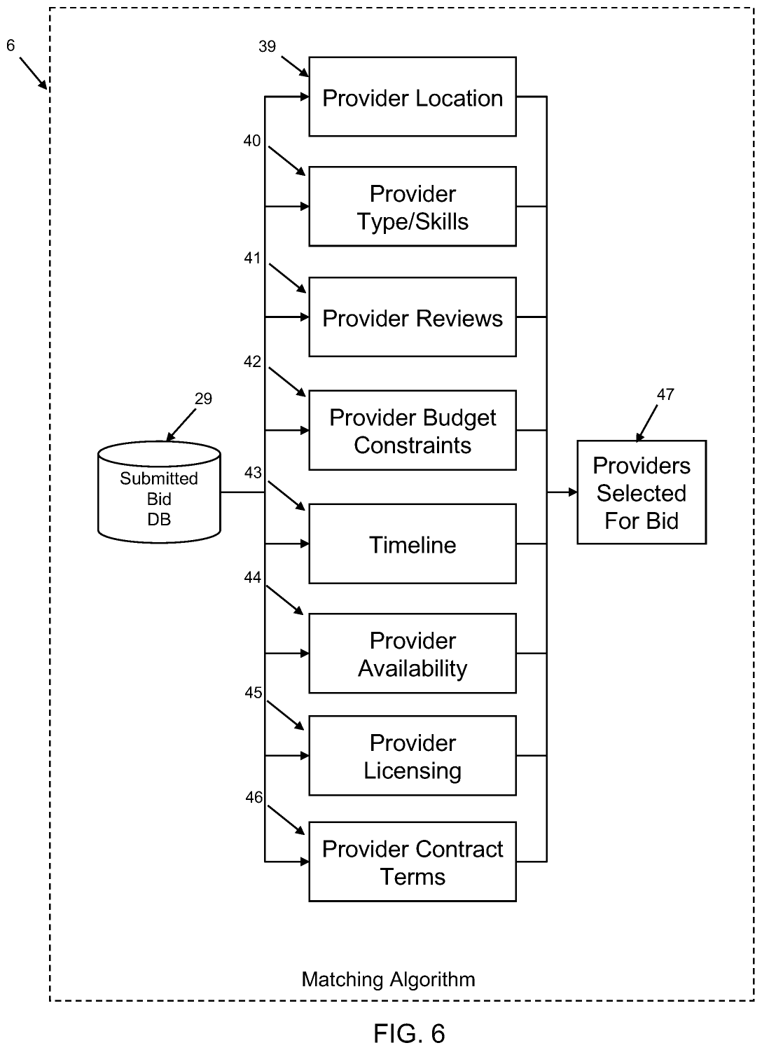

FIG. 6 shows the features and functions of matching algorithm 6. Once a user submits a bid and the bid is stored in the submitted project database 29, matching algorithm 6 determines an appropriate set of providers for bids based on a variety of criteria in the submitted bid as specified by the user. Provider location 39 is matched with the location indicated in the submitted bid. Providers located within a reasonable radius, as adjustable in the platform by both the user and the provider, are matched with the location of the project. The next matching criterial is provider type/skills 40. Only providers that offer the type of work or skills are matched with the submitted bid. If the user has specified a minimum provider review level (say 4 out of 5 possible stars), only providers that meet the minimum review criteria are selected for bidding.

If a provider has setup any timeline constraints in their profile, those are matched with the project timeline requirements specified in the submitted project by the user in timeline 43. If the provider would be unable to meet the user's timeline requirement, they are not selected for bidding. If a provider has marked that they are unavailable in the project timeframe in their user profile, this would also cause them not to be matched for providing a bid in provider availability 44.

Provider licensing 45 matches state/city/local licensing requirements for the specific project or any requirements set by the user for licensing in the bid. If the provider has the correct license, and meets the other criteria, they can be selected for bidding. Lastly, if either the user or provider has set any specific required contract terms either for the specific project or generally, they must match in provider contract terms 46 if the provider is to be selected for bid. Once all the criteria are compared, providers selected for bid 47 are sent the submitted project for bidding. If no providers are selected for bid, the user will be notified which user criteria are limiting the matching, such as budget, project timeline, rating, skills or location radius should be adjusted to be matched with more providers. For providers, if their set project criteria limit their matches, the platform will provide guidance to adjust their adjustable criteria such as project location radius, budget and timeline.

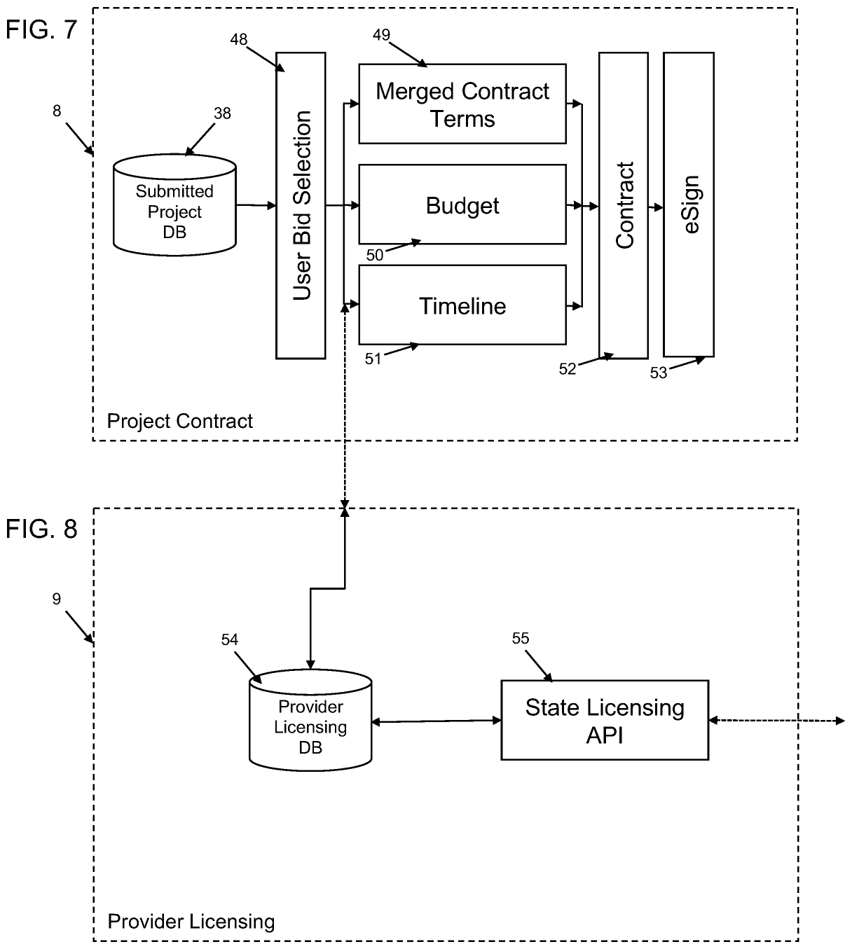

FIG. 7 outlines the automated contract creation and electronic signature capabilities of the platform in the project contract module 8. Bids for the selected project are stored in the submitted project database 38. The user reviews the relevant bids and selects the winning bid in user bid selection 48. The platform assembles the merged contract terms 49 from the user's requirements and the winning provider bid. These merged terms are automatically included in the contract. The platform further assembles the budget 50 and project timeline 51 from the winning bid and includes these details in the final contract 52. The contract 52 is submitted to both the user and provider for esign 53 (electronic signature). The present invention may include a proprietary electronic signature functionality or integrate solutions from DocuSign, Adobe, Hellosign or other electronic signature solutions well known in the art.

FIG. 8 shows the provider licensing module 9 consisting of provider licensing database 54 and state licensing API 55. Provider licensing database 54 includes records of all the state/city/local licenses uploaded by providers as they create their accounts. These licenses may also be manually verified by third parties. Additionally, for state, city and municipalities that provide the functionality, state licensing API 55 provides connectivity through any provided application programing interfaces (APIs) available for license verification. In this way, relevant provider licenses can be automatically verified and updated without human intervention.

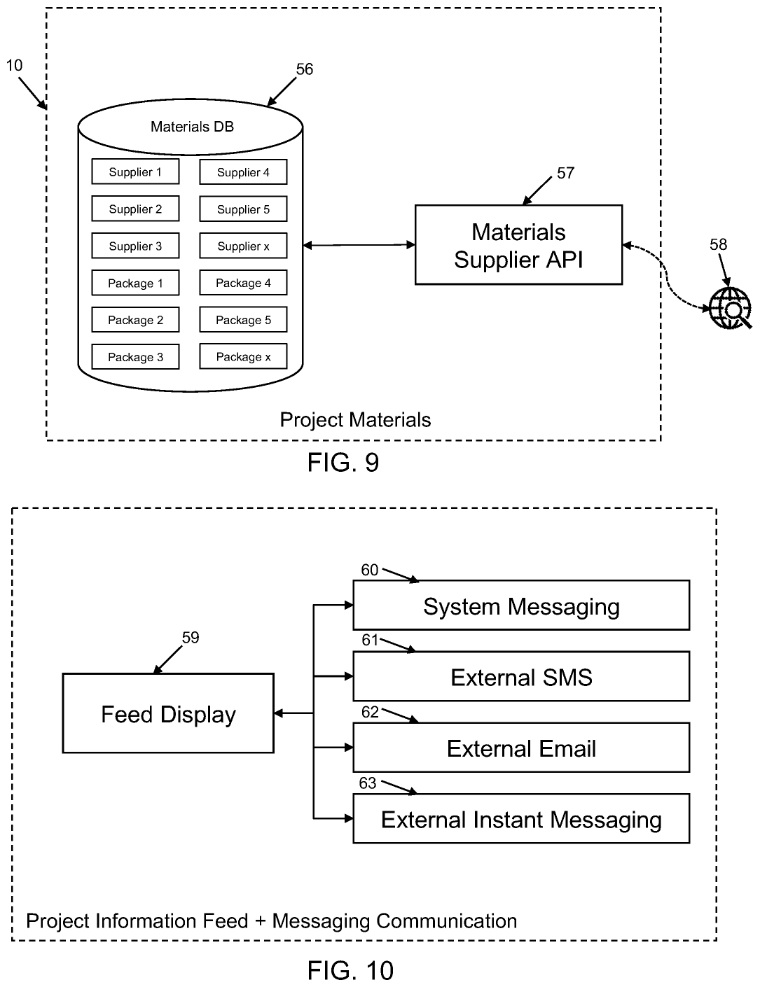

FIG. 9 shows the project materials module 10 which allows users to select various materials for their projects from a variety of suppliers. Project materials could include appliances, tile, flooring, carpet, paint, roofing materials, cabinets, bathroom materials, doors, trim, building systems, mechanical elements and any other materials that would be suitable for a home or office improvement project. Materials database 56 includes databases of project materials provided by various suppliers. These products can be indexed by supplier, product type or accessed through search. The database includes product information, pricing, specifications, availability, lead time, shipping costs and all other relevant product information. Project materials database 56 can contain products from any number of suppliers.

Materials DB also includes pre-selected product Packages 1-x. These packages are pre-populated with popular design options for various common projects such as kitchen and bathroom remodels, interior refreshes, exterior projects such as decks and patios and other common projects. For example, a number of popular packages for bathroom remodels could be created including a vanity, faucets for the sink and shower/bathtub, tile, toilets and other fixtures. Such packages could also be created for kitchens including cabinets, appliances, countertops, backsplash and flooring. Such package options are flexible, can be created in nearly infinite variations and updated as trends change in the projects presented.

Additionally, contractors may provide specific pricing packages for installation of specific materials, i.e. flooring, tile, fixtures, etc. Additionally, contractors may provide pricing for add on projects such as installation of various electrical items such as outlets, speaker wiring, light fixtures, other fixtures, or any type of project relevant to the providers skills that includes a product available from the materials DB. The materials DB may further provide suggested materials that are frequently purchased together based on previous client selection for similar projects.

Ideally, updates of the materials database 56 are available from the materials supplier API 57. The materials supplier API is connected directly to the various suppliers through the internet 58 so all the relevant product details are updated automatically.

FIG. 10 shows the project information feed 11 and messaging communication 12 modules. Feed display 59 shows all project information and updates in a time based feed starting with project submission, bid receipt, contract delivery/execution, project updates, milestones, project completion, billing, reviews, communication between user and provider and any other project information. System messaging 60 is a platform proprietary messaging system that allows communication between users and providers on the platform. External SMS 61 module allows the platform to communicate through SMS/text messaging known in the art. External email module 61 allows sending and receiving email in formats well known in the art. Emails can be composed on the platform and sent to users of platforms like Gmail, Yahoo, Apple Mail, Outlook and any other. External instant messaging module 63 enables integration with many instant messaging platforms such as WhatsApp, Facebook messenger, GChat and many others. Project information feed 11 further may provide a frequently asked questions (“FAQ”) sections for platform usage and other useful information. The user interface for the platform further includes a search function, this search function can be used to locate providers, materials and/or information in the project information feed and utilizes keyword searching and other search methodologies well known in the art. The messaging functionality may also be utilized by a user to contact a reference user offered by a provider as an example of a successfully completed project.

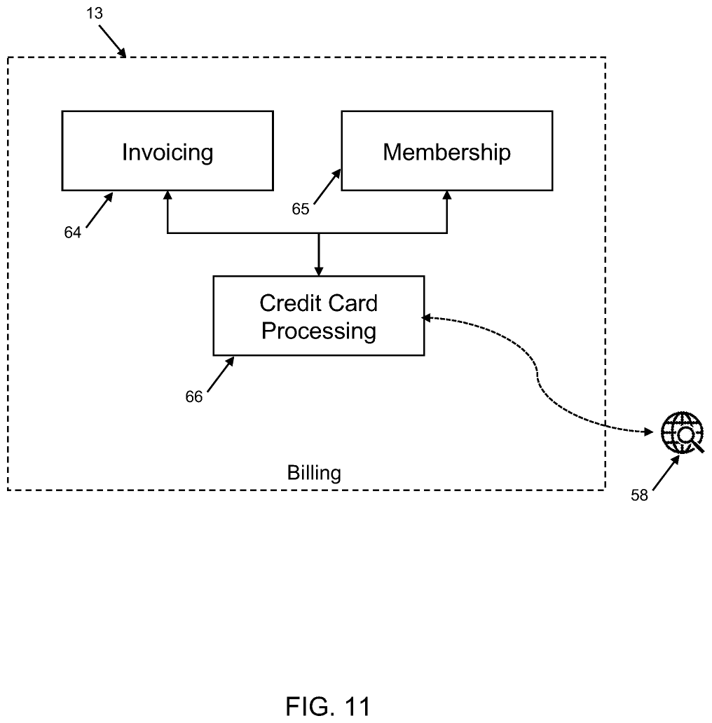

FIG. 11 outlines the billing module 13. Invoicing module 64 generates invoices for project milestones and completed projects as reported by providers. Invoicing module 64 is integrated with the project contract 8 so that invoices are generated based on agreed pricing, timelines and project terms. Invoices are sent to users through the system communications means and when approved, sent to credit card processing module 66 where provided credit card information is processed for payment. This can be a proprietary system developed specifically for this platform or third party payment processors well known in the art such as Square, Stripe, etc. Visa, Mastercard and American Express are anticipated to be accepted by the system. Credit card processing module 66 is connected directly to the internet 58.

Membership module 65 manages membership fees for users and providers based on their membership type and costs. It is anticipated that user memberships will be free but that providers will pay a percentage of each invoice submitted for payment as their membership fee. Materials providers memberships will also be paid based on a revenue share model. While the initial model is free for users and paid for providers, many other revenue models are anticipated.

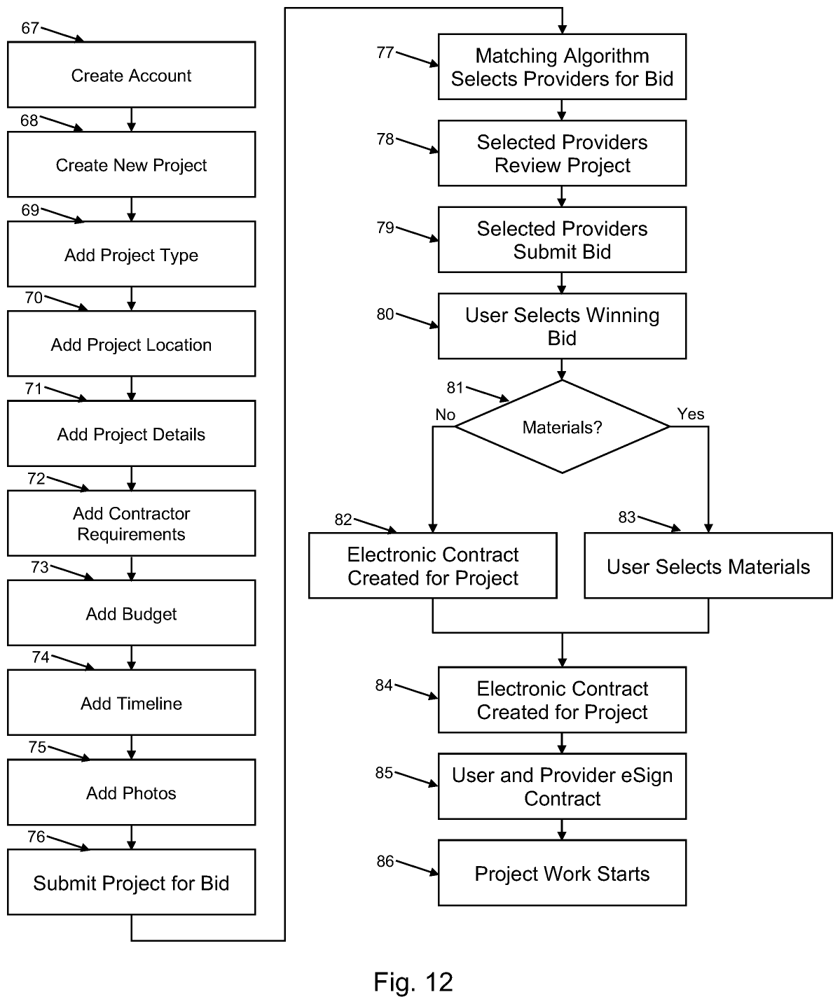

FIG. 12 shows the steps that a platform user goes through to setup their account, submit a project and start work on a project. In create account 67, the user sets up their user account providing a username, password, name and contact information. Single Sign On (SSO) options from Google, Apple and/or Facebook are supported. The user selects create new project 68. In the new project, they add project type 69, this can be a variety of supported projects like construction, contracting, roofing, plumbing, electrical, flooring/carpeting, tile, bathroom, painting, exterior work, decking, pool, landscaping, handyman and/or general. Any type of home or office improvement project is anticipated to be supported by the platform, but a system of this type could be used for any project. The user adds the project location 70 which could be an address, ZIP code, or GPS coordinates (shared by a mobile device or computer).

Add project details 71 allows the user to add narrative details about the project requirements and expectations. Add contractor requirements 72 allows the user to add any specific contractor requirements like licensing or skills. Add budget 73 allows the user to input a budget range (minimum to maximum), choose preselected budget ranges or input specific budget instructions. Add timeline 74 allows the user to select pre-populated timeline options like 1) As soon as possible; 2) within the next month; 3) 2-3 months, 4) 4-6 months and 5) within the next year. The user can also input any timeline requirements in a free form text box. Add photos 75 enables the user to add photos of their project location, desired project design and/or any other relevant photos for review by the provider. Once all the details are collected, the user will submit project for bid 76. The matching algorithm (as described prior) will match the submitted project with available providers based on the criteria previously disclosed. If no providers are selected for bid, the user will be notified which user criteria are limiting the matching, such as budget, project timeline, rating, skills or location radius should be adjusted to be matched with more providers. The selected providers will review the project in 78 and selected providers submit bids in 79. The user will selected the winning bid from the submitted bid in step 80.

If the user is purchasing materials for the project, and wants to select them through the platform, they can do so at the time of bid selection. If they add materials, they can select the materials in 83 those materials will be added to the electronic contract in 84. If not, they will have the option to add materials later. The user will have the option of adding individual materials or selecting a popular package for the project type they are bidding. Amounts of materials will be estimated by the platform and updated by the provider after measurements are taken. The user may choose materials preselected by the provider or add on materials with installation costs offered by the provider. The electronic contract for the project is created in 82 if it does not include materials. The user and provider electronically sign the contract in 85 and work can start in step 85.

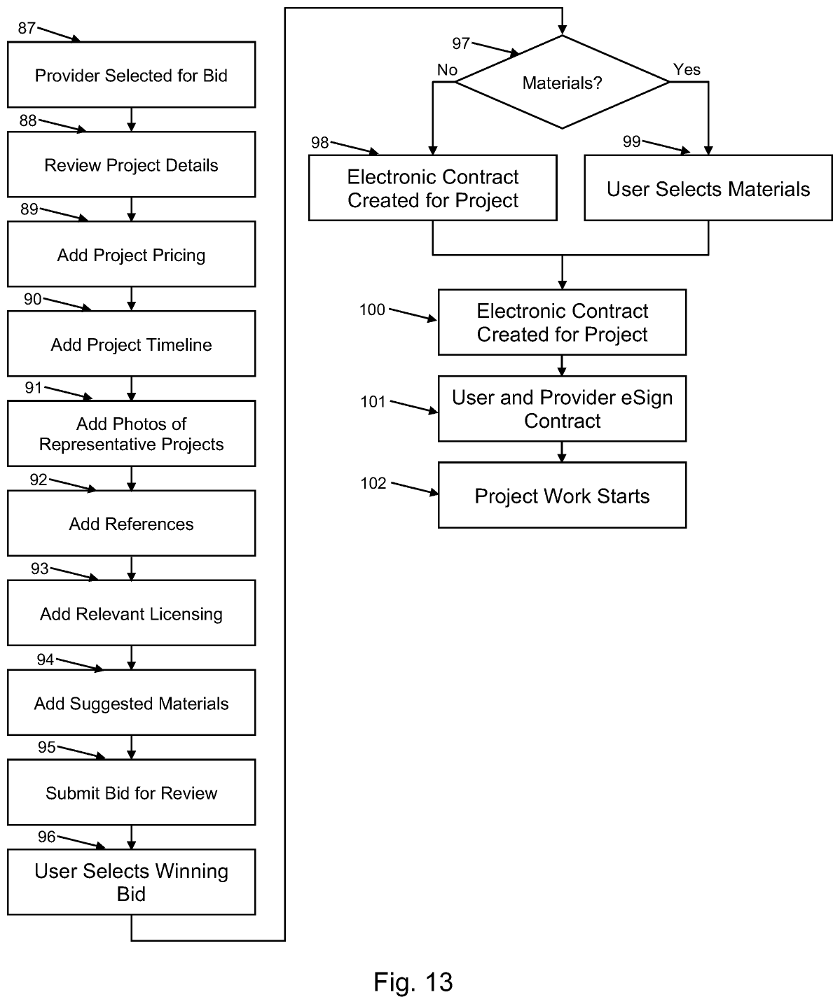

FIG. 13 outlines the steps for a provider to submit a bid after being selected by the matching algorithm to respond to a user submitted project. After a provider is selected for bid in 87, they review the project details in 88. The provider adds project pricing in 89 and a project timeline in 90. The provider is able to upload photos of representative projects in 91 and references from past clients in 92. If licensing is required for the project, the provider can add the required licenses in add relevant licensing 93. If materials are required for the proposal, the provider may select examples from the project materials module for sharing with the user. The provider submits the bid for review in 95 and the user selects the winning bid in 96. Providers that are not selected for the project will be notified that they have not been selected and given feedback on how to provide a better winning bid, such as budget adjustment, timeline adjustment, etc. These suggestions will be given in a way to maintain privacy and confidentiality for the user and other providers.

If materials are required for the project, the user selects the materials in 99 with provider suggested materials highlighted. If no materials are required, the electronic contract is created in 98. If materials are selected, they are added to the electronic contract, which is created in 100. Materials can be either individually selected or selected as a popular package as described earlier. The amount of materials can be estimated by the platform or provider and updated once the final amounts are known. Both the user and provider sign the electronic contract in 101 and project work starts in 102.

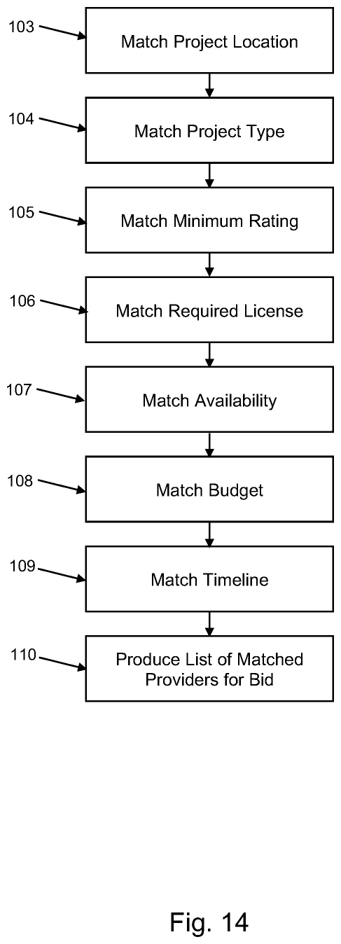

FIG. 14 outlines the steps for the matching algorithm to determine which providers are chosen to bid on a particular user project. The first step is to match the project location in 103. In this step, both the user and provider can select an acceptable radius around the project location for a provider. If the location matches, then in 104, the system seeks to match if the provider offers the project type required by the user. If so, the matching continues to 105 where the providers selected must meet the minimum rating required by the user. In 106, required licenses are verified. Budget requirements are matched in 108 and any project timeline criteria in 109. The remaining set of matched providers is produced at step 110.

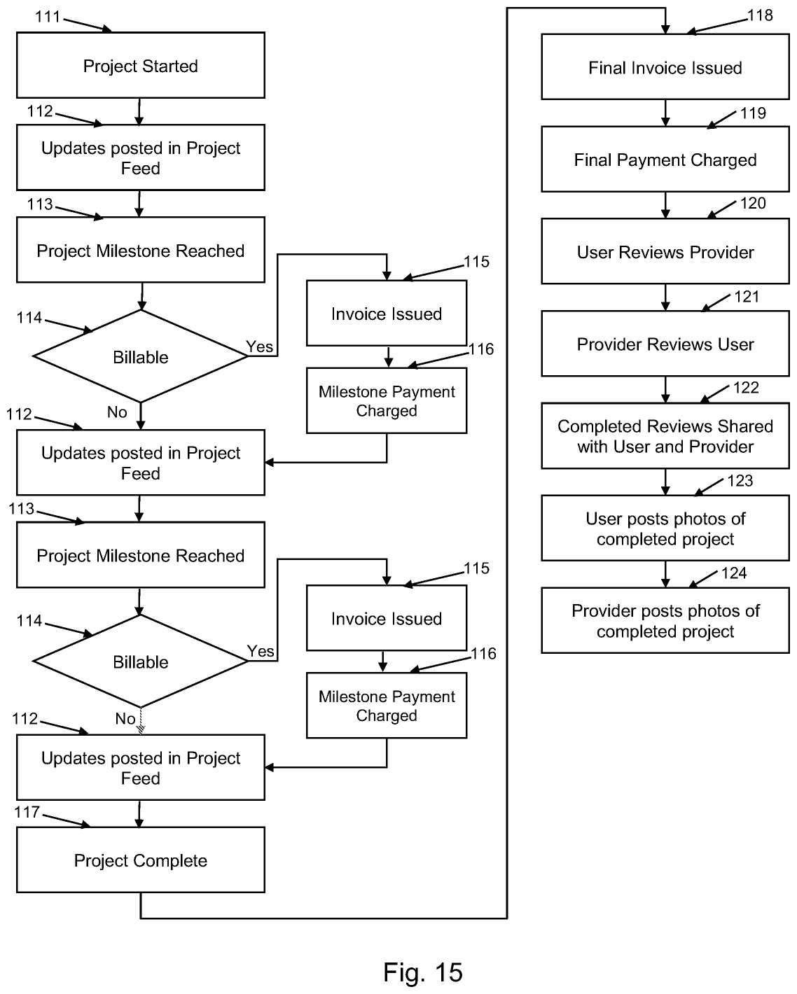

FIG. 15 shows the steps of completing a project on the present software platform. The project is started in 111. As progress continues, project updates are regularly posted in the project feed in 112. The project feed provides a visual and timeline-oriented display of project updates and details.

If a project milestone is reached in step 113, the system determines if that milestone triggers a billable event in 114. If the milestone is billable, an invoice is issued in 115 and a milestone payment charged in 116. At each update and/or milestone, updates are posted in project feed 112. Once the project is completed in 117, the final invoice is issued in 118 and the final payment charged in 119. In step 120, the user is requested to review the provider. The review will include a total star rating that is calculated by ratings from 1-5 (5 being highest and 1 being lowest) on key project quality and timing criteria. The user will also have the opportunity to add freeform text to the review.

Concurrently to the user reviewing the provider, the provider will similarly review the user. The user review criteria will be established based on a different set of questions but results in a similar 1-5 star rating. The provider is also able to add free form text to the review. Once the user and provider have completed their reviews, the completed reviews are shared with the provider and user in 122.

In step 123, the user is invited to add photos to the completed project and to share them publicly on the platform. Similarly, the provider is also invited to add photos of the project in 124. If the user authorizes public sharing of the project photos, the provider's photos will also be shared with other platform users.

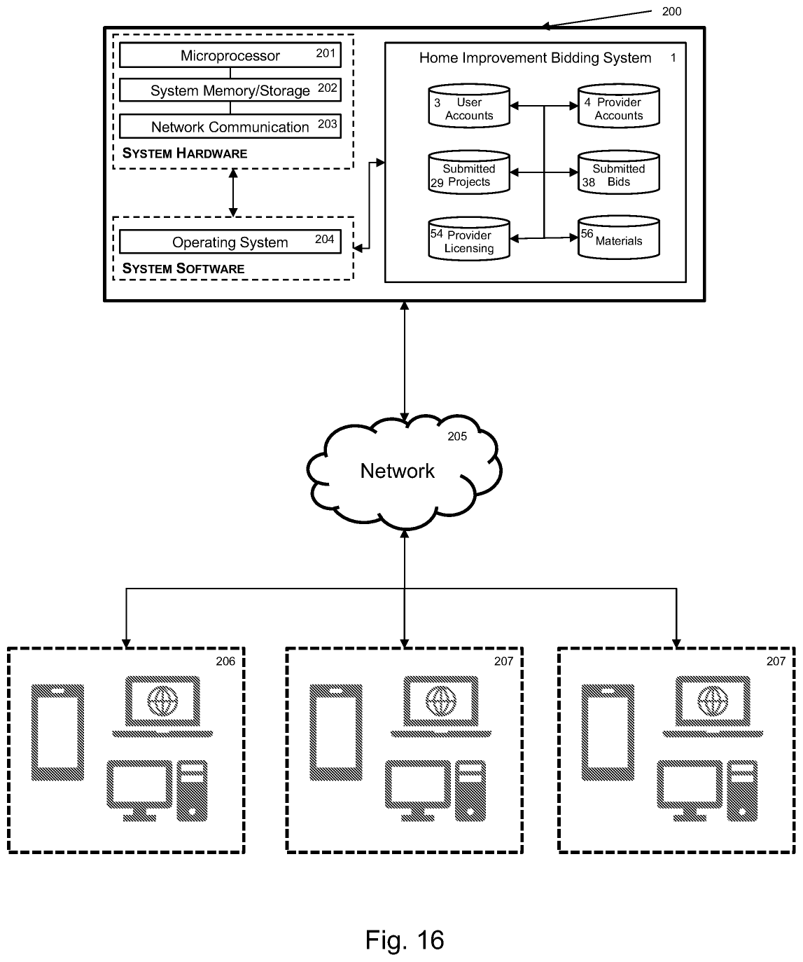

FIG. 16 shows a complete view of home improvement bidding system 1 including the relevant servers and databases. Application server 200 hosts home improvement bidding system 1 and includes microprocessor 201, system memory/storage 202, network communication 203 and operating system 204. Microprocessor 201 can be any suitable microprocessor known in the art, including those manufactured by Intel, AMD, Apple and ARM. System memory/storage 202 can be any combination of random access memory (RAM), non-volatile memory (FLASH) and hard disk storage as well known in the art. Network communication 203 can be any network communication system that is capable of communicating with any network, but in this case, the internet as well known in the art. Operating System 204 may be UNIX, Linux, MacOS, Windows, or any other operating system known in the art. The above are typically chosen to be utilized as servers with high volume operation in server configurations similar to Amazon Web Services and others.

Home improvement bidding system 1 is hosted on application server 200 and includes all the software code to operate the system and various databases, as described in this application, including buy not limited to user accounts database 3, provider accounts database 4, submitted projects database 29, submitted bids database 38, provider licensing database 54 and materials database 56.

User device 206 is connected to network 205. In this case, user device 206 could be any desktop, laptop or mobile device such as those running Microsoft Windows, MacOS, iOS and Android operating systems. Network 205 here is the internet. Similarly provider devices 207 could also be any desktop, laptop or mobile device such as those running Microsoft Windows, MacOS, iOS and Android operating systems. These embodiments are not meant to be limiting and any suitable combinations of hardware and software could be utilized.

Although the present invention has been described in relation to the above disclosed preferred embodiment, many modifications in design, materials and manufacturing are possible while still maintaining the novel features and advantages of the invention. The preferred embodiment is not meant to limit the scope of the patent in any way, and it should be given the broadest possible interpretation consistent with the language of the disclosure on the whole.

1. A computer implemented system for posting, matching and bidding on home improvement projects, the computer implemented system comprising at least one processor coupled to a computer readable storage device having instructions stored thereon which, when executed by the at least one processor, cause the at least one processor to perform operations comprising:
receiving, from a provider interface, from at least one provider a provider account comprising a set of provider information,
assembling the sets of provider information from the at least one provider into a set of eligible providers,
receiving, from a user interface, by a user, a home improvement project for bidding by the at least one provider, the home improvement project comprising a set of home improvement project information,
matching, by a matching computer algorithm, the set of eligible providers with the set of home improvement project information, based on a matching criteria, to create a set of matching providers from the set of eligible providers,
inviting the set of matching providers to submit a bid for the home improvement project,
submitting, by the provider interface, a bid for the home improvement project, the bid comprising the provider information, a price for the home improvement project and a completion date for the home improvement project, wherein each bid is assembled into a set of bids for review by the user,
reviewing, by the user through the user interface, the set of bids,
selecting, by the user, a selected bid for the home improvement project, wherein the selected bid further comprises a license as part of the provider information,
verifying, by an application server through a network, the license from the provider information for the selected bid,
selecting, by the user through the user interface and from a materials database, a set of selected materials for the home improvement project,
generating a project contract, comprising the selected bid and the set of selected materials,
executing, by the user through the user interface, the project contract,
executing, by the provider through the provider interface, the project contract,
displaying, through the user interface, a project information feed of progress updates for the home improvement project, and
generating a bill based on the project contract for review and payment by the user through the user interface.

2. The computer implemented system of claim 1 wherein the provider information comprises a provider location, a set of one or more provider services offered, and provider contact information comprising a telephone number and an email address.

3. The computer implemented system of claim 2 wherein the matching criteria include the provider location and the set of one or more provider services offered.

4. The computer implemented system of claim 1 wherein the materials database further comprises one or more sets of preselected materials for a home improvement project.

5. The computer implemented system of claim 1 wherein the provider, selects, through the provider interface and from the materials database, a set of selected materials for the home improvement project.

6. The computer implemented system of claim 1 wherein the home improvement project is selected from the group comprising: painting, carpentry, bathroom remodel, tile work, carpeting, flooring, electrical, plumbing, handy man, general contractor and kitchen remodel.

7. The computer implemented system of claim 1 wherein the home improvement project further comprises additional provider requirements from the group comprising: minimum review rating, licenses held by the provider, provider years in business, location and project completion date.

8. The computer implemented system of claim 1 wherein the project contract is executed by electronic signature.

9. The computer implemented system of claim 1 where the project information feed is displayed using means from one of the group of the comprising: email, text messaging, SMS messaging, chat rooms, private message, direct message and a workspace collaboration tool.

10. A system for posting, matching and bidding on home improvement projects, the computer implemented system comprising:
at least one user device comprising a microprocessor, a memory, a display controller, a means for communication with a network, the user device configured to utilized by a user,
at least one provider device comprising a microprocessor, a memory, a display controller, a means for communication with the network, the provider device configured to utilized by a provider,
an application server comprising a microprocessor, a memory, a display controller, a means for communication with the network, the application server further comprising a user accounts database, a provider accounts database, a submitted project database, a submitted bid database, a provider licensing database, and a materials database, the application server configured to perform operations comprising:
receiving, from a provider device, from at least one provider a provider account comprising a set of provider information, the provider information being stored in the provider accounts database,
assembling the sets of provider information from the at least one provider into a set of eligible providers,
receiving, from a user device, by a user, a home improvement project for bidding by the at least one provider, the home improvement project comprising a set of home improvement project information, the home improvement project being stored in the submitted projects database,
matching, by a matching computer algorithm, the set of eligible providers with the set of home improvement project information, based on a matching criteria, to create a set of matching providers from the set of eligible providers,
inviting the set of matching providers to submit a bid for the home improvement project,
submitting, by the provider device, a bid for the home improvement project, the bid comprising the provider information, a price for the home improvement project and a completion date for the home improvement project, the bid being stored in the submitted bid database wherein each bid is assembled into a set of bids for review by the user,
reviewing, by the user on the user device, the set of bids,
selecting, by the user, a selected bid for the home improvement project, wherein the selected bid further comprises a license as part of the provider information wherein the license is stored in the provider licensing database,
verifying, the application server through a network, the license from the provider information for the selected bid,
selecting, by the user on the user device and from the materials database, a set of selected materials for the home improvement project,
generating a project contract, comprising the selected bid and the set of selected materials,
executing, by the user on the user device, the project contract,
executing, by the provider on the provider device, the project contract,
displaying, on the user device and the provider device, a project information feed of progress updates for the home improvement project, and
generating a bill based on the project contract for review and payment by the user on the user device.

11. The system of claim 10 wherein the provider information comprises a provider location, a set of one or more provider services offered, and provider contact information comprising a telephone number and an email address.

12. The system of claim 11 wherein the matching criteria include the provider location and the set of one or more provider services offered.

13. The system of claim 10 wherein the materials database further comprises one or more sets of preselected materials for a home improvement project.

14. The system of claim 10 wherein the provider, selects, on the provider device and from the materials database, a set of selected materials for the home improvement project.

15. The system of claim 10 wherein the home improvement project is selected from the group comprising: painting, carpentry, bathroom remodel, tile work, carpeting, flooring, electrical, plumbing, handy man, general contractor and kitchen remodel.

16. The system of claim 10 wherein the home improvement project further comprises additional provider requirements from the group comprising: minimum review rating, licenses held by the provider, provider years in business, location and project completion date.

17. The system of claim 10 wherein the project contract is executed by electronic signature.

18. The system of claim 10 where the project information feed is displayed using means from one of the group of the comprising: email, text messaging, SMS messaging, chat rooms, private message, direct message and a workspace collaboration tool.
